(19) United States
(12) Patent Application Publication
(10) Pub. No.: US 2023/0075160 A1
(43) Pub. Date: Mar. 9, 2023

(54) DRYING RACK

(71) Applicant: Green Life Racks LLC, Upperlake, CA (US)

(72) Inventors: Brian Retzloff, Upperlake, CA (US); Kevin Retzloff, Willits, CA (US)

(21) Appl. No.: 17/493,183

(22) Filed: Oct. 4, 2021

Related U.S. Application Data
(63) Continuation-in-part of application No. 29/806,881, filed on Sep. 7, 2021, now Pat. No. D969434.

(51) Int. Cl. A47B 47/02; A47B 75/00; F26B 25/06

(52) U.S. Cl. CPC A47B 47/027; A47B 75/00; F26B 25/063; F26B 2200/02

(57) ABSTRACT

A drying rack having a stainless steel rectangular tubed frame with two vertical frame members and at least three horizontal frame members. The horizontal frame members have a plurality of rails extending from the horizontal members. The each rail of the plurality of rails is each equally spaced and extends from opposites sides of each horizontal member. The rails are configured to hold cannabis plant matter after harvest. The rails may be angled slightly for helping to retain the cannabis plant matter on the rails during use. The drying rack is on casters for mobility and rotation.

### CROSS-REFERENCE TO RELATED APPLICATIONS

The present invention is a continuation in part to design patent application Ser. No. 29/806,881 filed Sep. 7, 2021, which is hereby incorporated in its entirety at least by reference.

### BACKGROUND OF THE INVENTION

### 1. Field of the Invention

The present invention relates generally to a drying rack for plant matter.

### Brief Summary of the Invention

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a drying rack is provided, comprising a frame having a first vertical frame member and a second vertical frame member, wherein the first vertical frame member and the second vertical frame member are connected by at least one horizontal member; and, a plurality of rails extending from the at least one horizontal member, wherein the plurality of rails are configured to hold plant matter.

In one embodiment, the first horizontal member is connected at a top portion of each of the first and second vertical frame members. In one embodiment, the frame comprises a pair of perpendicular frame members, each perpendicular frame member positioned perpendicularly in relation to the first vertical frame member and the second vertical frame member to support each vertical frame member. In another embodiment, each of the first and the second vertical frame members are centrally positioned on each perpendicular frame member of the pair of perpendicular frame members. In yet another embodiment, trusses are provided between the first and second vertical frame members and each of perpendicular frame members of the pair of perpendicular frame members. In one embodiment, casters are provided at each end of each perpendicular frame member of the pair of perpendicular frame members, wherein the casters enable the drying rack to be transported and enable rotation of 360 degrees. In one embodiment, the at least one horizontal member includes a first horizontal member, a second horizontal member, and a third horizontal member. In another embodiment, a fourth horizontal member is provided. In one embodiment, the frame is rectangularly tube shaped. In another embodiment, the frame and the plurality of rails are constructed of stainless steel. In one embodiment, the plurality of rails extend from opposite sides of the at least one horizontal member. In another embodiment, each rail of the plurality of rails is 17″ in length, 1″ in height, and ⅛″ in width. In one embodiment, each rail of the plurality of rails is tapered upwards at an angle upwards from each respective attachment point on the at least one horizontal member. In yet another embodiment, the angle of the taper is between 1-5 degrees. In one embodiment, the plant matter is cannabis plant matter.

In another aspect of the invention, an additional drying rack is provided, comprising a steel rectangular tubed frame comprises a first vertical frame member, a second vertical frame member, a first perpendicular frame member, and a second perpendicular frame member, wherein the first perpendicular frame member and a second perpendicular frame member are perpendicular to the first vertical frame member and the second vertical frame member respectively; a first horizontal member, a second horizontal member, and a third horizontal member, wherein the first horizontal member, the second horizontal member, and the third horizontal member are attached to and extend between the first vertical frame member and the second vertical frame member; and, a plurality of rails extending from the first horizontal member, the second horizontal member, and the third horizontal member, wherein the plurality of rails are configured to hold plant matter.

In one embodiment, the plurality of rails are free of bumps, hooks, bends, and other obstructions that may damage the plant matter. In another embodiment, the plurality of rails are welded in positioned on the first horizontal member, the second horizontal member, and the third horizontal member. In one embodiment, the plurality of rails movable in position on the first horizontal member, the second horizontal member, and the third horizontal member.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a drying rack according to an embodiment of the present invention.

FIG. 2 is a side view of an alternative drying rack according to an embodiment of the present invention.

FIG. 3 is a perspective view illustrating a number of drying racks stored together when not in use according to an embodiment of the present invention.

FIG. 4 is a perspective view of a drying rack in use according to an embodiment of the present invention.

FIG. 5 is a detailed view of an alternative drying rack rail according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a drying rack for plant matter.

For the purpose of this disclosure, the word “a” is defined to mean “at least one.” The word “plant matter” may include any plant related matter. The invention is optimized for the use of cannabis plant matter, wherein the word “cannabis” is defined to mean “any species of the cannabis genus of flowing plants including Cannabis sativa, cannabis indica, Cannabis ruderalis, and hemp.” The terminology includes the words above specifically mentioned, derivatives thereof, and words of similar import.

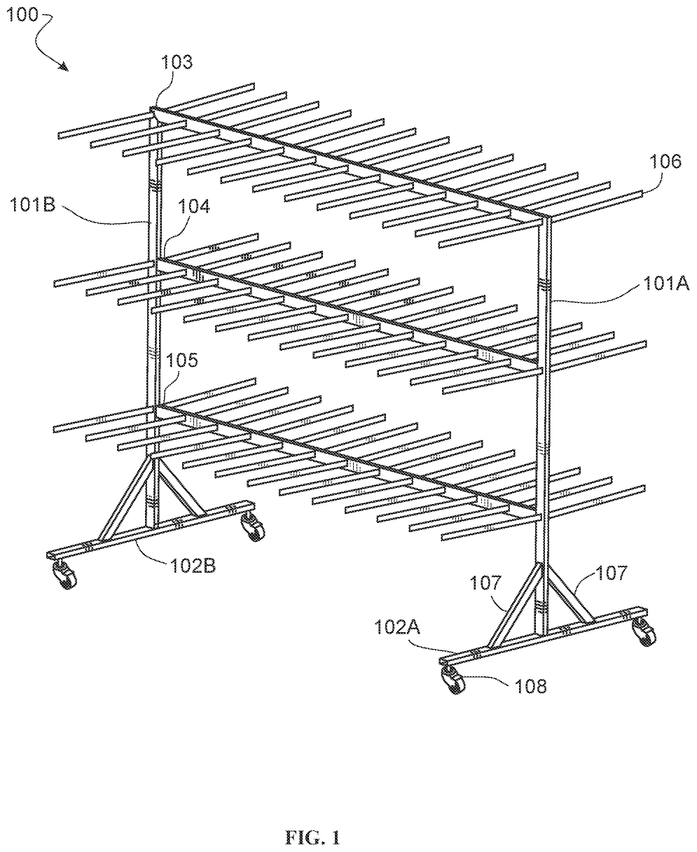

FIG. 1 is a perspective view of a drying rack according to an embodiment of the present invention. Referring now to FIG. 1, the drying rack 100 is illustrated. In one embodiment, the drying rack comprises a frame which includes at least a first vertical frame member 101A and a second vertical frame member 101b, wherein the first vertical frame member 101A and the second vertical frame member 101b are connected by at least one horizontal member 103. In one embodiment, the horizontal member 103 is connected at a top portion of each vertical frame member (101A/101B). In some embodiments, the frame further includes a pair of perpendicular frame members 102A and 102B, wherein each perpendicular frame member is positioned perpendicularly in relation to the first vertical frame member 101A and the second vertical frame member 101b to support each vertical frame member. Preferably, the vertical frame members are centrally positioned on each perpendicular frame member. In some embodiments, trusses 107 are provided and configured to support the first vertical frame member 101A and second vertical frame member 101b. As the drying rack is intended to be moved, casters 108 are provided at each end of each perpendicular frame member.

In one embodiment, the casters are 4″ casters, but it should be understood that the size of the casters may vary as needed. In one embodiment, the frame members are 1″ by 2″ rectangular steel tubes. In one embodiment, the rectangular steel tubes are 14 gauge stainless steel tubes. It should be understood that the material may vary without departing from the spirit and scope of the invention.

Preferably, the drying rack includes at least three horizontal members (103, 104, 105) connected between each vertical frame member. In some embodiments, the horizontal members are equally spaced. In alternative embodiments, the horizontal members are spaced for optimized use of the height or size of the plant matter intended to be dried via the present invention. The details of use will be described in further details below.

In one embodiment, a plurality of rails 106 extend from each vertical surface of each horizontal member, i.e. two rails extend from opposite sides of each horizontal member. Preferably, the rails are equally spaced from each adjacent rail along the horizontal member. In one embodiment, the rails are spaced 8″ apart. The spacing may vary, however, the spacing should adequately allow for space for the plant matter to hang from each rail, which will be explained in greater detail below. In one embodiment, the rails are 17″ in length, 1″ in height, and ⅛″ in width. The rails are provided on each horizontal member. In some embodiments, each rail of the plurality of rails 106 is tapered upwards from each respective attachment point on its respective horizontal member. The angle of the taper may vary, wherein the angle should be sufficient to provide resistance of the plant matter from failing off the railing. As one in the art would appreciate, the taper helps on the plant matter stay on the plurality of the rails 106 during use. In one embodiment, the angle of the taper is between 1-5 degrees. In alternative embodiments, the angle of the taper is between 0-10 degrees.

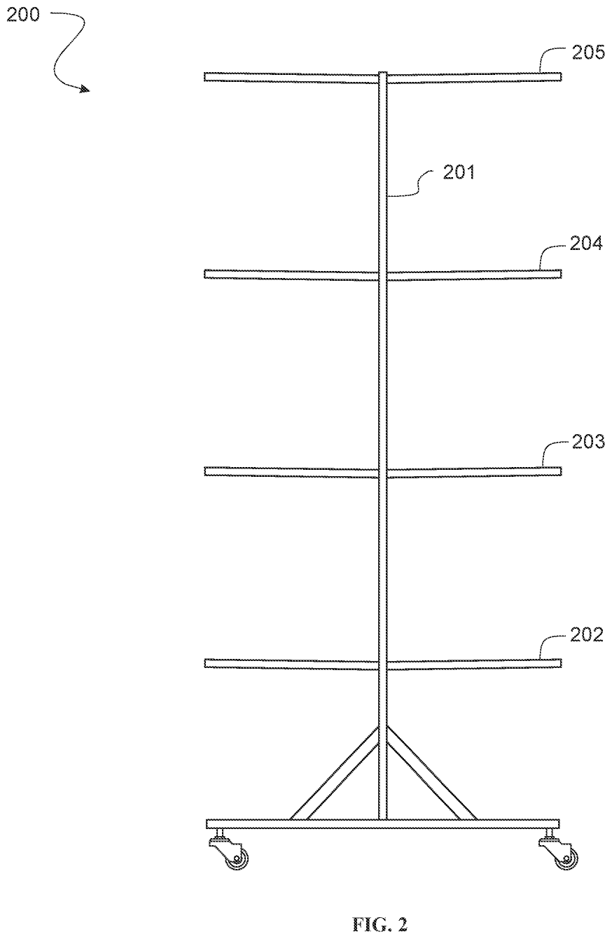

FIG. 2 is a side view of an alternative drying rack according to an embodiment of the present invention. Referring now to FIG. 2, the alternative drying rack 200 is illustrated. This alternative drying rack 200 is similar to the drying rack 100 explained and illustrated in FIG. 1, however, the alternative drying rack has an additional horizontal member on frame 201 providing four levels of rails (202, 203, 204, and 205). It should be understood that the height and the number of levels vary. In one embodiment, the drying rack may vary between 6′-6″ and 10′-6″, providing a 6′-6″, 8′-6″, and 10′-6″ height option. These heights are merely provided as examples. The height is varied based on the number of horizontal members and the spacing between each horizontal member. In this view, the taper as previously discussed is visible.

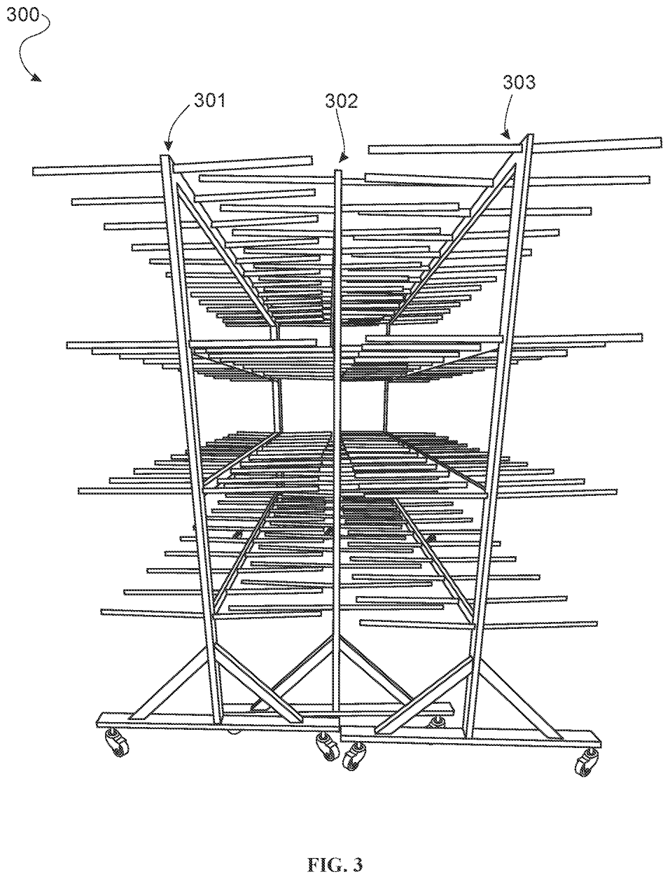

FIG. 3 is a perspective view illustrating a number of drying racks stored together when not in use according to an embodiment of the present invention. Referring now to FIG. 3, a number of drying racks 301, 302, and 303 are stored together when not in use. Due to the design of the drying rack, multiple drying racks can be stored within each adjacent drying rack, wherein the plurality of rails of one drying rack are stored in the spacing of the adjacent drying rack's plurality of rails as illustrated. Advantageously, this limits the amount of space the drying racks occupy when they are not in use.

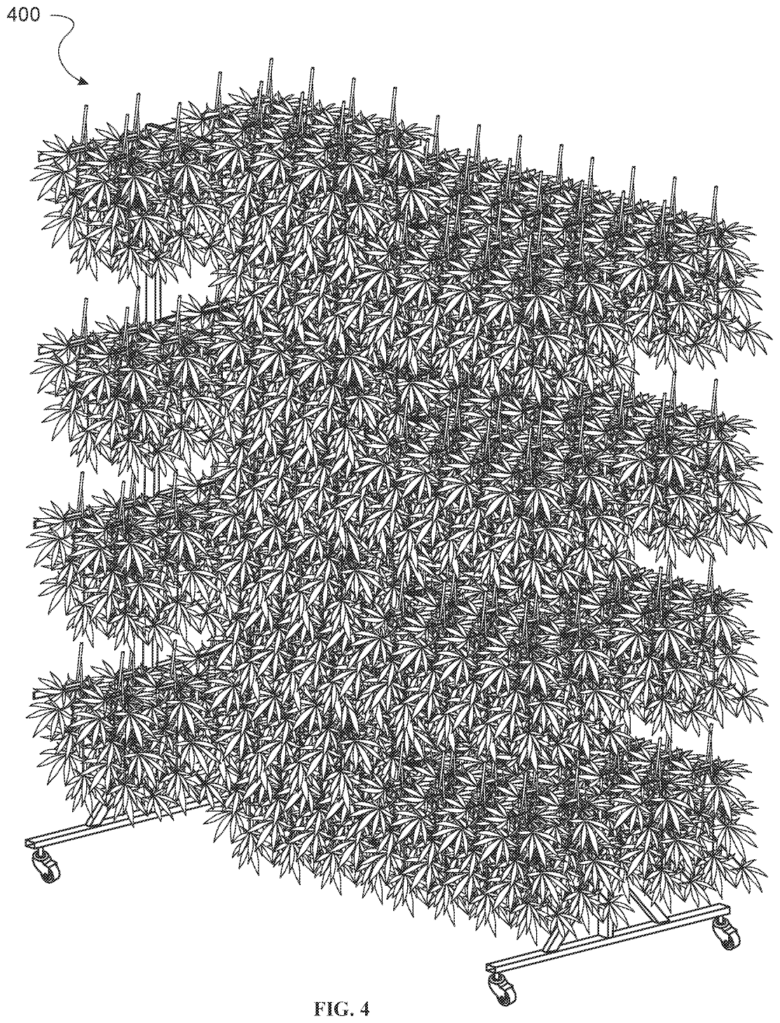

FIG. 4 is a perspective view of a drying rack in use according to an embodiment of the present invention. Referring now to FIG. 4, the drying rack in use 400 for drying plant matter. In the preferred embodiment, the drying rack is intended and optimized for use for drying cannabis plant matter. As well known in the art, cannabis is harvested and then dried via various methods, including the hanging method. The most common method is via the use of clothes lines wherein the cannabis is hung via their branches, until the plant matter (leaves and flowers) are sufficiently dry until the next step of the cannabis processing, trimming is performed. As illustrated, one can appreciate how much plant matter can be hung on the plurality of rails of the drying rack of the present invention. For example, the drying racks of 6′-6″, 8′-6″, and 10′-6″ as described above replace 110′, 170′ and 260′ of standard clothe line hanging method allowing significantly more plant matter to be dried in the same square footage.

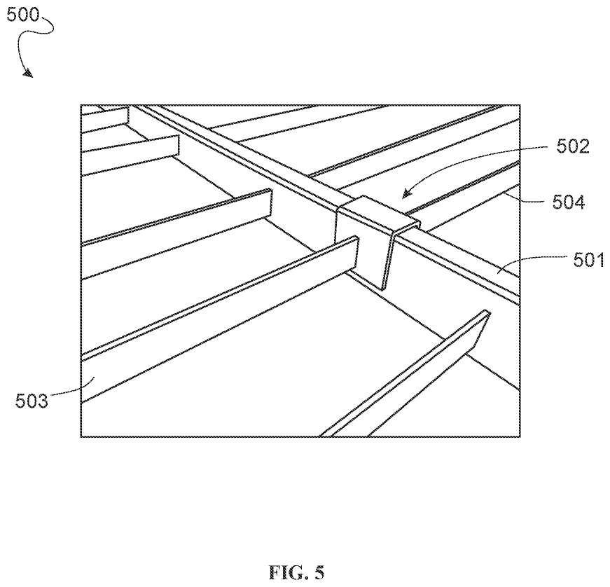

FIG. 5 is a detailed view of an alternative drying rack rail according to an embodiment of the present invention. Referring now to FIG. 5, an alternative drying rack rail 500 is illustrated. Advantageously, the alternative drying rack rail provides a means for moving the rails along a horizontal member 501. In one embodiment, the alternative drying rack rail comprises a U-shaped central member 502 with two rails 503 and 504 attached to each side of the U-shaped central member 502. By providing a means of moving the rails, a user is able to move and position the rails at any position along the horizontal member 501. This is useful to modify the rack to dry a variety of plant matter and plant matter sizes.

The frame, rails, and other components of the drying rack, including the vertical and horizontal members of the present invention are configured to be welded together in a configuration as illustrated in FIGS. 1-5. Only in the embodiment described in FIG. 5 of the alternative drying rack rail 500 is configured to be movable. The drying rack itself may rotate 360 degrees via the casters 108 on a ground surface.

In some embodiments, the rails should be free of bumps, hooks, bends, and other obstructions that may damage the cannabis plant matter. Thus, the rails should be at one consistent angle, wherein the angle is the taper as previously discussed. In alternative embodiments, the rails are at a 0 degree angle with no taper present.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1.-15. (canceled)

16. A drying rack comprising:
a steel tubed frame comprises a first vertical frame member, a second vertical frame member, a first perpendicular frame member, and a second perpendicular frame member, wherein the first perpendicular frame member and a second perpendicular frame member are perpendicular to the first vertical frame member and the second vertical frame member respectively;
a first horizontal member, a second horizontal member, and a third horizontal member, wherein the first horizontal ember, the second horizontal member, and the third horizontal member are attached to the first vertical frame member and the second vertical frame member, the first horizontal member attached to a first top portion of the first vertical frame member and a second top portion the second vertical frame member such that the first horizontal member and the first vertical frame member form a first right angle and the first horizontal member and the second vertical frame member form a second right angle; and,
a plurality of rails extending from the first horizontal member, the second horizontal member, and the third horizontal member, wherein the plurality of rails are configured to hold cannabis plant matter, wherein plurality of rails are welded in position and each rail of the plurality of rails is tapered upwards at an angle between 1-10 degrees, wherein the angle is configured to help the cannabis plant matter stay on the plurality of rails.

17. The drying rack of claim 16, wherein the plurality of rails are free of bumps, hooks, bends, and other obstructions that may damage the cannabis plant matter.

18.-19. (canceled)

20. A drying rack comprising:
a steel rectangular tubed frame comprises a first vertical frame member, a second vertical frame member, a first perpendicular frame member, and a second perpendicular frame member, wherein the first perpendicular frame member and a second perpendicular frame member are perpendicular to the first vertical frame member and the second vertical frame member respectively;
a first horizontal member, a second horizontal member, and a third horizontal member, wherein the first horizontal member, the second horizontal member, and the third horizontal member are attached to the first vertical frame member and the second vertical frame member, the first horizontal member attached to a first top portion of the first vertical frame member and a second top portion the second vertical frame member such that the first horizontal member and the first vertical frame member form a first right angle and the first horizontal member and the second vertical frame member form a second right angle; and,
at least one rail configured to hold cannabis plant matter, the at least one rail having a U-shaped sleeve configured to removably engage the first horizontal member, the second horizontal member, or the third horizontal member such that the at least one rail is movable on the drying rack without the use of fasteners, wherein the at least one rail includes two rails portions extending in opposite directions from the U-shaped sleeve centrally positioned on the at least one rail.

21. The drying rack of claim 20, wherein the two rail portions are tapered upwards at an angle between 1-10 degrees, wherein the angle is configured to help the cannabis plant matter stay on the at least one rail.
